(19) United States
(12) Patent Application Publication
(10) Pub. No.: US 2011/0016866 A1
(43) Pub. Date: Jan. 27, 2011

(54) APPARATUS FOR FUEL INJECTION IN A TURBINE ENGINE

(75) Inventors: Gregory Allen Boardman, Greer, SC (US); Ronald Chila, Greer, SC (US); Nishant Govindbhai Parsania, Bangalore (IN); Hasan Karim, Simpsonville, SC (US)

Correspondence Address: GE Energy-Global Patent Operation;Fletcher Yoder PC, P.O. Box 692289, Houston, TX, 77269-2289, US

(73) Assignee: GENERAL ELECTRIC COMPANY, Schenectady, NY (US)

(21) Appl. No.: 12/507,298

(22) Filed: Jul. 22, 2009

(51) Int. Cl. F02C 7/12; F02C 7/22

(52) U.S. Cl. 60/730; 60/740

(57) ABSTRACT

In one embodiment, a system includes a fuel injector including a liquid fuel passage extending to a first port in a tip portion. The fuel injector also includes a selectable flow passage extending to a second port in the tip portion. The selectable flow passage surrounds the liquid fuel passage to the tip portion, the selectable flow passage is configured to selectively receive a gas fuel flow and an air flow, and the selectable flow passage has a flow temperature configured to cool a liquid fuel flowing through the liquid fuel passage to reduce coking.

### BACKGROUND OF THE INVENTION

The subject matter disclosed herein relates to a gas turbine engine and, more specifically, to a fuel nozzle.

Gas turbine engines include one or more combustors, which receive and combust compressed air and fuel to produce hot combustion gases. For example, the gas turbine engine may include multiple combustors positioned circumferentially around the rotational axis. The combustors may inject either a liquid fuel, a gas fuel, or a combination of the two fuels via fuel injectors positioned at a base of the combustor. Unfortunately, due to the high temperatures associated with combustion, liquid fuel may experience coking prior to exiting the fuel injectors. Coking is a condition where fuel begins to crack, forming carbon particles. These particles may become attached to inside walls of the liquid fuel injectors. Over time, the particles may detach from the walls and clog the tips of the liquid fuel injectors, thereby interfering with liquid fuel flow.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a fuel injector including a liquid fuel passage leading to a liquid fuel port and a gas fuel passage leading to a gas fuel port. The system also includes an air compressor configured to supply an air flow to the gas fuel passage while a liquid fuel flows through the liquid fuel passage. Furthermore, the system includes a heat exchanger configured to cool the air flow.

In a second embodiment, a system includes a fuel injector including a liquid fuel passage extending to a first port in a tip portion. The fuel injector also includes a selectable flow passage extending to a second port in the tip portion. The selectable flow passage surrounds the liquid fuel passage to the tip portion, the selectable flow passage is configured to selectively receive a gas fuel flow and an air flow, and the selectable flow passage has a flow temperature configured to cool a liquid fuel flowing through the liquid fuel passage to reduce coking.

In a third embodiment, a system includes a fuel injector including a liquid fuel passage extending to a first port. The fuel injector also includes a selectable flow passage extending to a second port. The selectable flow passage is configured to selectively receive a gas fuel flow during a gas fuel mode and an air flow during a liquid fuel mode, and the second port is configured to direct the air flow to atomize a liquid fuel flow from the first port during the liquid fuel mode.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a turbine system having a fuel nozzle coupled to a combustor, wherein the fuel nozzle is configured to reduce coking within liquid fuel injectors in accordance with certain embodiments of the present technique;

FIG. 2 is a cutaway side view of the turbine system, as shown in FIG. 1, in accordance with certain embodiments of the present technique;

FIG. 3 is a cutaway side view of the combustor, as shown in FIG. 1, with a fuel nozzle coupled to an end cover of the combustor in accordance with certain embodiments of the present technique;

FIG. 4 is a perspective view of the fuel nozzle, as shown in FIG. 3, with a set of premixer tubes in accordance with certain embodiments of the present technique;

FIG. 5 is a cutaway perspective view of the fuel nozzle, as shown in FIG. 4, in accordance with certain embodiments of the present technique;

FIG. 6 is an exploded perspective view of the fuel nozzle, as shown in FIG. 4, in accordance with certain embodiments of the present technique;

FIG. 7 is a cross-sectional side view of the fuel nozzle, as shown in FIG. 4, in accordance with certain embodiments of the present technique;

FIG. 8 is a side view of a premixer tube, as shown in FIG. 7, in accordance with certain embodiments of the present technique;

FIG. 9 is a cross-sectional side view of a premixer tube, taken along line 9-9 of FIG. 8, in accordance with certain embodiments of the present technique;

FIG. 10 is a cross-sectional side view of a premixer tube, taken along line 10-10 of FIG. 8, in accordance with certain embodiments of the present technique;

FIG. 11 is a cross-sectional side view of a premixer tube, taken along line 11-11 of FIG. 8, in accordance with certain embodiments of the present technique;

FIG. 12 is a perspective view of a liquid fuel cartridge disposed within a gas fuel injector, as shown in FIG. 7, in accordance with certain embodiments of the present technique;

FIG. 13 is a top view of the liquid fuel cartridge disposed within the gas fuel injector of FIG. 12 in accordance with certain embodiments of the present technique;

FIG. 14 is a cross-sectional side view of the liquid fuel cartridge disposed within the gas fuel injector, taken along line 14-14 of FIG. 13, in accordance with certain embodiments of the present technique;

FIG. 15 is a detailed cross-sectional side view of the liquid fuel cartridge disposed within the gas fuel injector, taken within line 15-15 of FIG. 14, in accordance with certain embodiments of the present technique;

FIG. 16 is a cross-sectional side view of the liquid fuel cartridge disposed within the gas fuel injector, taken along line 16-16 of FIG. 13, in accordance with certain embodiments of the present technique;

FIG. 17 is a perspective view of a tip portion of the liquid fuel cartridge, as shown in FIG. 12, in accordance with certain embodiments of the present technique; and

FIG. 18 is a cross-sectional side view of the gas fuel injector, as shown in FIG. 7, disposed within an end cover in accordance with certain embodiments of the present technique.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present disclosure may substantially reduce or eliminate coking within a liquid fuel passage by surrounding the liquid fuel passage with cooling air and/or gas fuel to provide insulation from hot combustion gases. Specifically, a turbine system may include a fuel nozzle having a liquid fuel cartridge disposed within a gas fuel injector. The liquid fuel cartridge and the gas fuel injector may be configured to inject a liquid and/or gas fuel into a premixer tube for subsequent mixing with air prior to combustion. During periods of gas fuel operation, the turbine system may flow gas fuel through a selectable flow passage within the gas fuel injector. Because the liquid fuel cartridge may be substantially disposed within the selectable flow passage, the flow of gas fuel may serve to insulate the liquid fuel cartridge, thereby substantially reducing or eliminating coking. During periods of liquid fuel operation, the turbine system may flow cooling air from a heat exchanger through the selectable flow passage to insulate the liquid fuel cartridge from hot combustion gases. In this arrangement, the cooling air may substantially reduce or eliminate coking of liquid fuel within the liquid fuel cartridge, thereby reducing the possibility of blocking the flow of liquid fuel into the premixer tube. In addition, the cooling air may be directed along the flow path of liquid fuel emanating from the liquid fuel cartridge, thereby enhancing atomization. Furthermore, the cooling air may reduce the temperature of the combustion reaction. The reduced temperature may serve to decrease exhaust emissions below regulatory levels without employing a complex and expensive water injection system. In certain embodiments, the liquid fuel cartridges may be easily removable from the fuel nozzle. Such embodiments may reduce maintenance costs and enable selection of a liquid fuel cartridge having features configured for a particular liquid fuel.

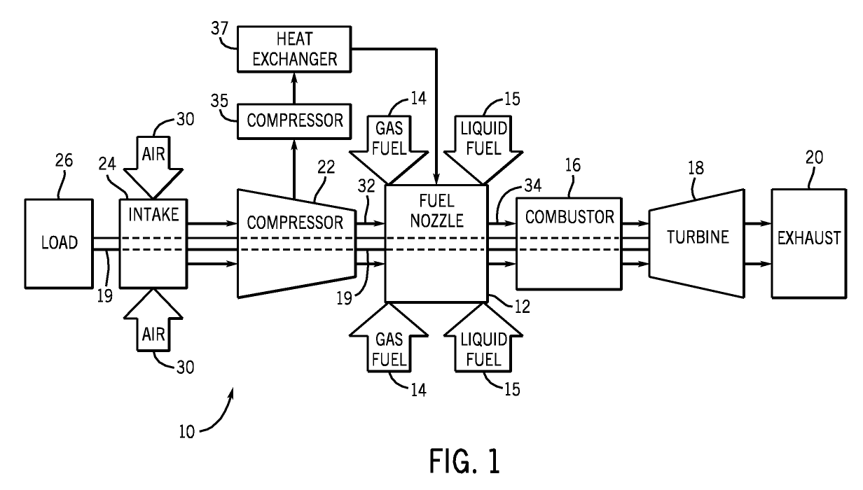

Turning now to the drawings and referring first to FIG. 1, a block diagram of an embodiment of a gas turbine system 10 is illustrated. The diagram includes fuel nozzle 12, gas fuel supply 14, liquid fuel supply 15, and combustor 16. As depicted, gas fuel supply 14 routes a gas fuel, such as natural gas, to the turbine system 10 through fuel nozzle 12 into combustor 16. Similarly, liquid fuel supply 15 routes a liquid fuel, such as kerosene or diesel fuel, to the turbine system 10. The turbine system 10 may operate in a liquid fuel mode, a gas fuel mode, or a combined mode (e.g., liquid/gas transition mode). As discussed below, the fuel nozzle 12 is configured to inject and mix the fuel with compressed air while substantially reducing or eliminating coking within liquid fuel injectors. The combustor 16 ignites and combusts the fuel-air mixture, and then passes hot pressurized exhaust gas into a turbine 18. The exhaust gas passes through turbine blades in the turbine 18, thereby driving the turbine 18 to rotate. In turn, the coupling between blades in turbine 18 and shaft 19 will cause the rotation of shaft 19, which is also coupled to several components throughout the turbine system 10, as illustrated. Eventually, the exhaust of the combustion process may exit the turbine system 10 via exhaust outlet 20.

In an embodiment of turbine system 10, compressor vanes or blades are included as components of compressor 22. Blades within compressor 22 may be coupled to shaft 19, and will rotate as shaft 19 is driven to rotate by turbine 18. Compressor 22 may intake air to turbine system 10 via air intake 24. Further, shaft 19 may be coupled to load 26, which may be powered via rotation of shaft 19. As appreciated, load 26 may be any suitable device that may generate power via the rotational output of turbine system 10, such as a power generation plant or an external mechanical load. For example, load 26 may include an electrical generator, a propeller of an airplane, and so forth. Air intake 24 draws air 30 into turbine system 10 via a suitable mechanism, such as a cold air intake, for subsequent mixture of air 30 with gas fuel supply 14 and/or liquid fuel supply 15 via fuel nozzle 12. As will be discussed in detail below, air 30 taken in by turbine system 10 may be fed and compressed into pressurized air by rotating blades within compressor 22. The pressurized air may then be fed into fuel nozzle 12, as shown by arrow 32. Fuel nozzle 12 may then mix the pressurized air and fuel, shown by numeral 34, to produce a suitable mixture ratio for combustion, e.g., a combustion that causes the fuel to more completely burn, so as not to waste fuel or cause excess emissions. An embodiment of turbine system 10 includes certain structures and components within fuel nozzle 12 to substantially reduce or eliminate coking within liquid fuel injectors, thereby establishing a proper flow of liquid fuel into the combustion zone.

As discussed in detail below, during periods when the turbine system 10 is operating in the liquid fuel mode, air may pass over liquid fuel injectors in the fuel nozzle 12 to prevent coking. Coking is a condition where fuel begins to crack, forming carbon particles. These particles may become attached to inside walls of the liquid fuel injectors. Over time, the particles may detach from the walls and clog the tips of the liquid fuel injectors. Coking may be substantially reduced or eliminated by maintaining the fuel within the liquid fuel injectors at a temperature below the coking temperature of the fuel. Specifically, the fuel nozzle 12 may be configured to flow air along the liquid fuel injectors at a temperature below the fuel coking temperature. In certain configurations, a portion of the air from an intermediate stage of the compressor 22 may be diverted to a secondary compressor 35 to increase air pressure. The air may then pass through a heat exchanger 37 to reduce the air temperature to a level below the coking temperature of the liquid fuel. For example, air from the intermediate stage of the compressor 22 may be approximately 300 to 700, 350 to 650, 400 to 600 or approximately 500 degrees Fahrenheit. Further compression in the compressor 35 may increase the air temperature to about 500 to 1000, 600 to 900, 700 to 800, or about 750 degrees Fahrenheit. The temperature at which coking occurs varies depending on the fuel. However, for typical petroleum based liquid fuels, where the fuel has not been treated with an anti-coke agent or the oxygen has not been removed, coking may start to occur at a temperature of approximately 280 degrees Fahrenheit. By further example, liquid petroleum based fuel may coke at temperatures greater than approximately 280, 380, 480, 580, 680, or 780 degrees Fahrenheit. Therefore, the heat exchanger 37 may be configured to reduce the temperature of the air from the compressor 35 to a temperature less than the coking temperature of the liquid fuel. In this manner, coking within the liquid fuel injectors may be significantly reduced or eliminated. In alternative embodiments, air from the compressor 22 may be routed directly to the heat exchanger 37 before flowing to the fuel nozzle 12. In addition, the fuel nozzle 12 may be configured such that the cooling air flows through the same passages used to inject gas fuel during periods of gas fuel operation. In this configuration, only one set of gas/air passages may be employed adjacent to the liquid fuel injectors. Such a configuration may reduce manufacturing costs associated with fuel nozzle construction. Furthermore, during transition periods when both liquid fuel and gas fuel are injected through the fuel nozzle 12, the flow of gas fuel adjacent to the liquid fuel may also serve to reduce coking, thereby obviating injection of the cooling airflow.

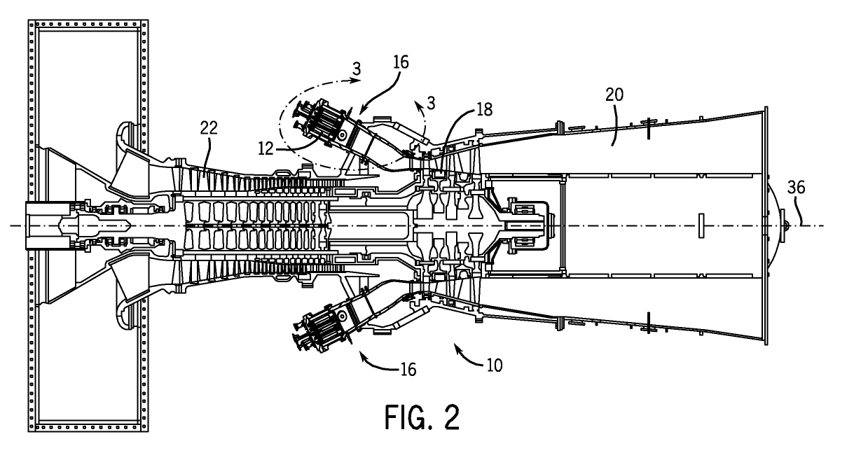

FIG. 2 shows a cutaway side view of an embodiment of turbine system 10. As depicted, the embodiment includes compressor 22, which is coupled to an annular array of combustors 16, e.g., six, eight, ten, or twelve combustors 16. Each combustor 16 includes at least one fuel nozzle 12 (e.g., 5, 10, 15, 20, 25, or more), which feeds an air-fuel mixture to a combustion zone located within each combustor 16. Combustion of the air-fuel mixture within combustors 16 will cause vanes or blades within turbine 18 to rotate as exhaust gas passes toward exhaust outlet 20. As will be discussed in detail below, certain embodiments of fuel nozzle 12 include a variety of unique features to reduce coking within liquid fuel injectors, thereby providing substantially unrestricted liquid fuel flow into the combustion zone.

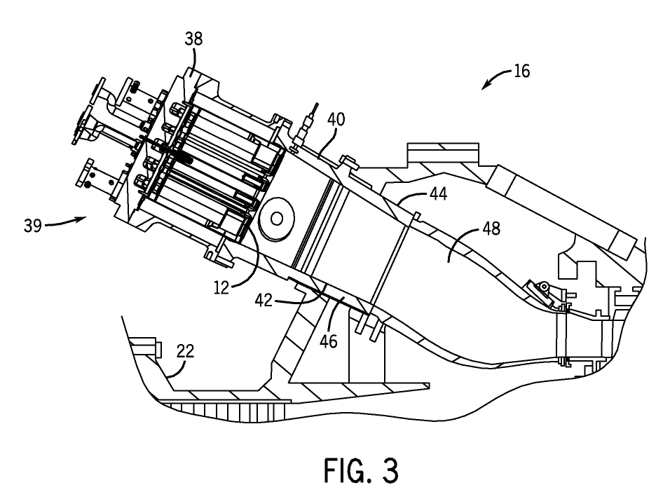

A detailed view of an embodiment of combustor 16, as shown in FIG. 2, is illustrated in FIG. 3. In the diagram, fuel nozzle 12 is attached to end cover 38 at a base or head end 39 of combustor 16. Compressed air and fuel are directed through end cover 38 to the fuel nozzle 12, which distributes an air-fuel mixture into combustor 16. The fuel nozzle 12 receives compressed air from the compressor 22 via a flow path around and partially through the combustor 16 from a downstream end to an upstream end (e.g., head end 39) of the combustor 16. In particular, the turbine system 10 includes a casing 40, which surrounds a liner 42 and flow sleeve 44 of the combustor 16. The compressed air passes between the casing 40 and the combustor 16 until it reaches the flow sleeve 44. Upon reaching the flow sleeve 44, the compressed air passes through perforations in the flow sleeve 44, enters a hollow annular space between the flow sleeve 44 and liner 42, and flows upstream toward the head end 39. In this manner, the compressed air effectively cools the combustor 16 prior to mixing with fuel for combustion. Upon reaching the head end 39, the compressed air flows into the fuel nozzle 12 for mixing with the fuel. In turn, the fuel nozzle 12 may distribute a pressurized air-fuel mixture into combustor 16, wherein combustion of the mixture occurs. The resultant exhaust gas flows through transition piece 48 to turbine 18, causing blades of turbine 18 to rotate, along with shaft 19. In general, the air-fuel mixture combusts downstream of the fuel nozzle 12 within combustor 16. Mixing of the air and fuel streams may depend on properties of each stream, such as fuel heating value, flow rates, and temperature. In particular, the pressurized air may be at a temperature, around 650-900° F. and fuel may be around 70-500° F. As discussed in detail below, the fuel nozzle 12 includes various features configured to substantially reduce or eliminate coking by insulating liquid fuel flow with cooling air and/or gas fuel.

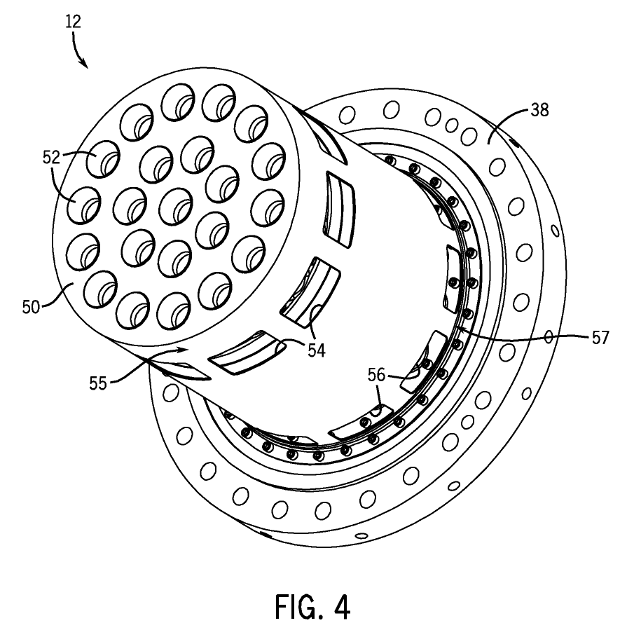

FIG. 4 shows a perspective view of a fuel nozzle 12 that may be used in the combustor 16 of FIG. 3. The fuel nozzle 12 includes a mini-nozzle cap 50 with multiple premixer tubes 52. First windows 54 may be positioned around the circumference of the mini-nozzle cap 50 to facilitate airflow into the cap 50 near a downstream portion 55 of the cap 50. Second windows 56 may also be located around the circumference of the mini-nozzle cap 50 closer to the end cover 38 to provide additional airflow near an upstream portion 57 of the cap 50. However, as discussed in further detail below, fuel nozzle 12 may be configured to direct airflow from both windows 54 and 56 into the premixer tubes 52 in a greater amount at the upstream portion 57 rather than the downstream portion 55. The number of first windows 54 and second windows 56 may vary based on desired airflow into the mini-nozzle cap 50. For example, the first and second windows 54 and 56 each may include a set of approximately 2, 4, 6, 8, 10, 12, 14, 16, 18, or 20 windows distributed about the circumference of the mini-nozzle cap 50; the present embodiment has 10 windows. However, the size and shape of these windows may be configured to conform to particular combustor 16 design considerations. The mini-nozzle cap 50 may be secured to the end cover 38, forming a complete fuel nozzle assembly 12.

As will be discussed in detail below, fuel and air may mix within the premixer tubes 52 in a manner reducing pressure oscillations prior to injection into the combustor 16. Air from the windows 54 and 56 may flow into the premixer tubes 52 and combine with fuel flowing through the end cover 38. The fuel and air may mix as they travel along the length of the premixer tubes 52. For example, each premixer tube 52 may include an increased length, angled perforations to induce swirl, and/or a non-perforated section downstream from a perforated section. These features may substantially increase residence time of the fuel and air and dampen pressure oscillations within the premixer tube 52. Upon exiting the tubes 52, the fuel-air mixture may be ignited, generating hot gas which powers the turbine 18.

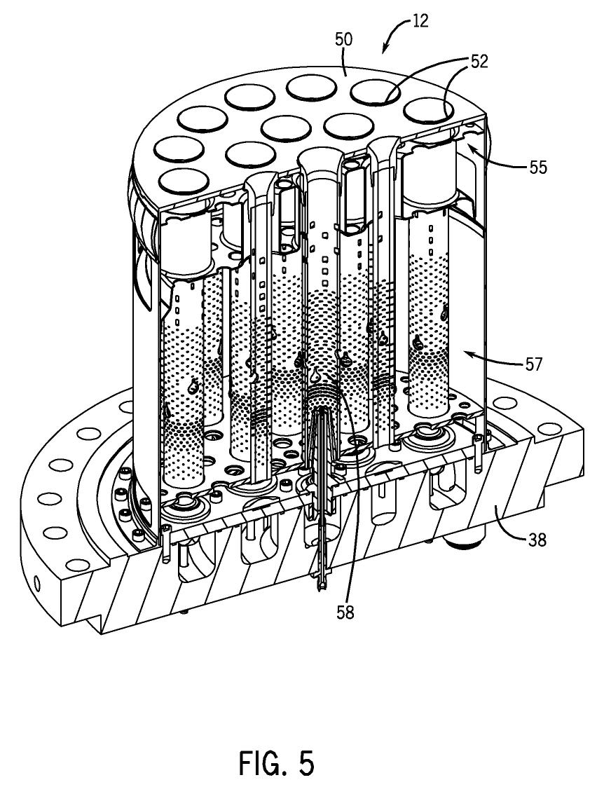

FIG. 5 presents a cross-section of the fuel nozzle 12 depicted in FIG. 4. This cross-section shows the premixer tubes 52 within the mini-nozzle cap 50. As can be seen in FIG. 5, each premixer tube 52 contains multiple perforations 58 along the longitudinal axis of the tube 52. These perforations 58 direct air from the windows 54 and 56 into the premixer tubes 52. The number of perforations and the size of each perforation may vary based on desired airflow into each premixer tube 52. Fuel may be injected through the end cover 38 and mix with the air entering through the perforations 58. Again, the position, orientation, and general arrangement of the perforations 58 may be configured to substantially increase residence time and dampen pressure oscillations in the fuel and air, thereby in turn substantially reducing oscillations in the combustion process occurring within the combustor 16 downstream from the fuel nozzle 12. For example, the percentage of perforations 58 may be higher in the upstream portion 57 rather than the downstream portion 55 of each premixer tube 52. Air entering through perforations 58 further upstream 57 travels a greater distance through the premixer tube 52, whereas air entering through perforations 58 further downstream 55 travels a shorter distance through the premixer tube 52. In certain embodiments, the perforations 58 may be sized relatively larger in the upstream portion 57 and relatively smaller in the downstream portion 55 of the premixer tube 52, or vice versa. For example, larger perforations 58 in the upstream portion 57 may result in a greater percentage of air flow entering through the upstream portion 57 of the premixer tube 52, which in turn leads to greater residence time in the premixer tube 52. In some embodiments, the perforations 58 may be angled to induce swirl to increase mixing, increase residence time, and dampen pressure oscillations in the air and fuel flows through the premixer tube 52. Eventually, after substantial dampening of the pressure oscillations in the fuel and air flows, the premixer tube 52 injects the fuel-air mixture into the combustor 16 for combustion.

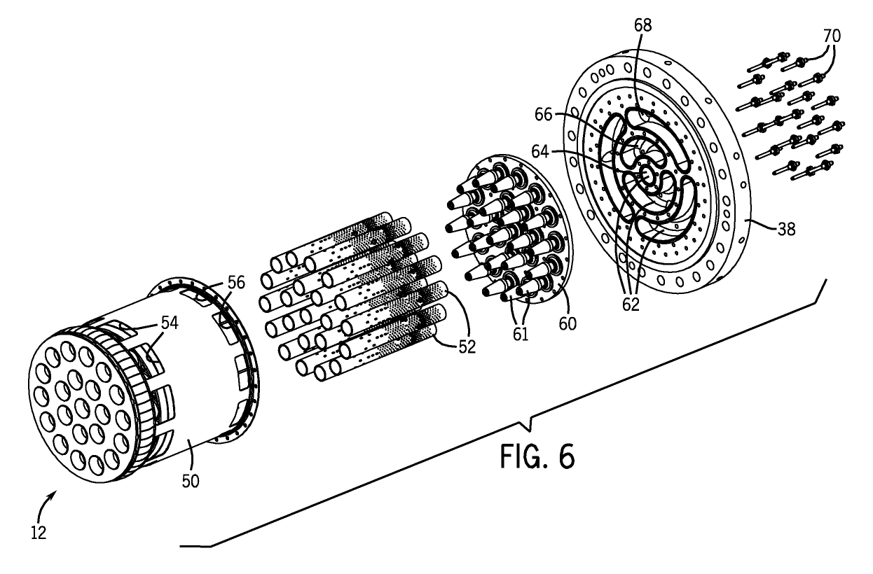

FIG. 6 is an exploded view of the fuel nozzle 12 depicted in FIG. 4. This figure further shows the configuration of premixer tubes 52 within the mini-nozzle cap 50. FIG. 6 also presents another perspective of the first windows 54 and the second windows 56. In addition, this figure illustrates the paths and structures for fuel supply into the base of each premixer tube 52.

Turbine engines may operate on liquid fuel, gas fuel, or a combination of the two. The fuel nozzle 12 presented in FIG. 6 facilitates both liquid and gas fuel flow into the premixer tubes 52. However, other embodiments may be configured to operate solely on liquid fuel or gas fuel. The gas fuel may enter the premixer tubes 52 through a gas injector plate 60. This plate 60, as shown, contains multiple cone-shaped gas fuel injectors 61 that supply gas to the premixer tubes 52. Gas may be supplied to the gas injector plate 60 through the end cover 38. The end cover 38 may include multiple galleries 62 (e.g., annular or arcuate shaped recess) that direct gas from the gas fuel supply 14 to the gas injector plate 60. The illustrated embodiment includes three galleries 62, e.g., first gallery 64, second gallery 66, and third gallery 68. Second gallery 66 and third gallery 68 are divided into multiple sections. However, continuous annular galleries 66 and 68 may be employed in alternative embodiments. The number of galleries may vary based on the configuration of the fuel nozzle 12. As can be seen in this figure, the gas fuel injectors 61 are arranged in two concentric circles surrounding a central injector 61. In this configuration, the first gallery 64 may supply gas to the central injector 61, the second gallery 66 may supply gas to the inner circle of injectors 61, and the third gallery 68 may supply gas to the outer circle of injectors 61. In this manner, gas fuel may be supplied to each premixer tube 52.

Liquid fuel may be supplied to the premixer tubes 52 through multiple liquid atomizer sticks or liquid fuel cartridges 70. Each liquid fuel cartridge 70 may pass through the end cover 38 and the gas injector plate 60. As will be discussed below, the tip of each liquid fuel cartridge 70 may be located within each gas fuel injector 61. In this configuration, both liquid and gas fuel may enter the premixer tubes 52. For example, the liquid fuel cartridges 70 may inject an atomized liquid fuel into each premixer tube 52. This atomized liquid may combine with the injected gas and the air within the premixer tubes 52. The mixture may then be ignited as it exits the fuel nozzle 12. As discussed in detail below, liquid fuel flowing through the liquid fuel cartridges 70 may be insulated from hot combustion gases by gas fuel and/or cooling air from the heat exchanger 37 flowing through the gas fuel injectors 61. This configuration may substantially reduce or eliminate coking with the liquid fuel cartridges 70, thereby maintaining the flow of liquid fuel into the premixer tubes 52.

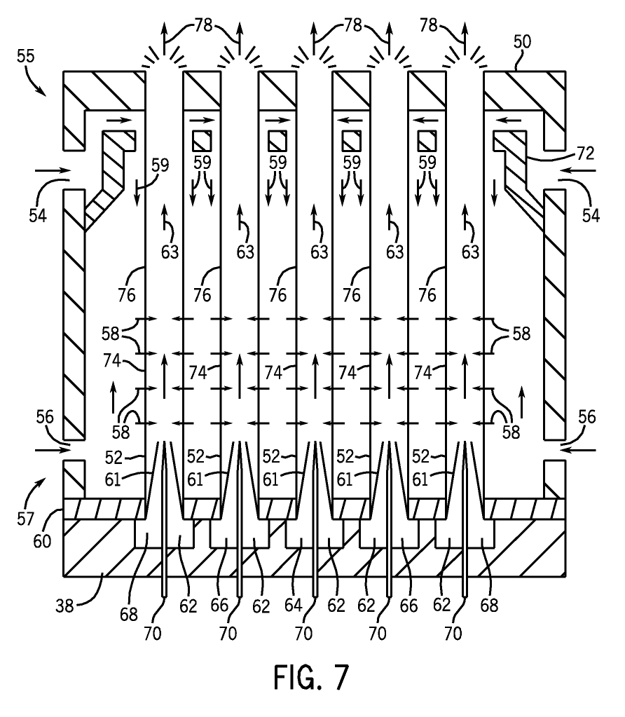

FIG. 7 shows a cross-section of the fuel nozzle 12 depicted in FIG. 4. As previously discussed, air may enter the mini-nozzle cap 50 through first windows 54 and second windows 56. This figure shows the path of air through the windows 54 and 56 to the perforations 58, through the perforations 58, and lengthwise along the premixer tubes 52. The first windows 54 direct air into the downstream portion 55 of the mini-nozzle cap 50 to facilitate cooling before the air passes into the premixer tubes 52 at the upstream portion 57. In other words, the air flow passes along an exterior of the premixer tubes 52 in an upstream direction 59 from the downstream portion 55 to the upstream portion 57 prior to passing through the perforations 58 into the premixer tubes 52. In this manner, the air flow 59 substantially cools the fuel nozzle 12, and particularly the premixer tubes 52, with greater effectiveness in the downstream portion 55 nearest the hot products of combustion in the combustor 16. The second windows 56 facilitate airflow into premixer tubes 52 more closely or directly into the perforations 58 at the upstream portion 57 of the premixer tubes 52. Only two first windows 54 and second windows 56 are represented in FIG. 7. However, as best seen in FIG. 4, these windows 54 and 56 may be arranged along the entire circumference of the mini-nozzle cap 50.

Air entering the first windows 54 may be directed to the downstream portion 55 of the mini-nozzle cap 50 by a guide or cooling plate 72. As can be seen in FIG. 7, the fuel nozzle 12 distributes the air flow from the first windows 54 both crosswise and parallel to the longitudinal axis of the fuel nozzle 12, e.g., distributing the air flow crosswise about all of the premixer tubes 52 and lengthwise in the upstream direction 59 toward the perforations 58. The air flow 59 from the windows 54 eventually combines with air flow from the windows 56 as the air flows pass GE Docket No. 237803-1 from windows 54 substantially cools the fuel nozzle 12 in the downstream portion 55. Thus, due to the hot products of combustion near the downstream portion 55, the air flow 59 from the windows 54 will be warmer than air flow from the second windows 56.

The first windows 54 in the present embodiment are approximately twice as large as the second windows 56. This configuration may ensure that the back side of the mini-nozzle cap 50 is sufficiently cooled, while reducing the air temperature entering the premixer tubes 52. However, window size ratio may vary based on the particular design considerations of the fuel nozzle 12. Furthermore, additional sets of windows may be employed in other embodiments.

The combined air flows enter the premixer tubes 52 through perforations 58 (shown with arrows) located along a perforated section 74 of the tubes 52. As previously discussed, fuel injectors may inject gas fuel, liquid fuel, or a combination thereof, into the premixer tubes 52. The configuration illustrated in FIG. 7 injects both gas and liquid fuels. Gas may be provided by the galleries 62 located directly below the injector plate 60 in the end cover 38. The same three-gallery configuration presented in FIG. 6 is employed in this embodiment. The first gallery 64 is located below the center premixer tube 52. The second gallery 66 surrounds the first gallery 64 in a coaxial or concentric arrangement, and provides gas to the next outer premixer tubes 52. The third gallery 68 surrounds the second gallery 66 in a coaxial or concentric arrangement, and provides gas to the outer premixer tubes 52. Gas may be injected into the premixer tubes 52 through gas fuel injectors 61. Similarly, liquid may be injected by liquid fuel cartridges 70. The liquid fuel cartridges 70 may inject liquid fuel at a pressure sufficient to induce atomization, or the formation of liquid fuel droplets. The liquid fuel may combine with the gas fuel and the air within the perforated section 74 of the premixer tubes 52. Additional mixing of the fuel and air may continue in a non-perforated section 76 downstream from the perforated section 74.

The combination of these two sections 74 and 76 may ensure that sufficient mixing of fuel and air occurs prior to combustion. For example, the non-perforated section 76 forces the air flow 59 to flow further upstream to the upstream portion 57, thereby increasing the flow path and residence time of all air flows passing through the premixer tubes 52. At the upstream portion 57, the air flows from both the downstream windows 54 and the upstream windows 56 pass through the perforations 58 in the perforated section 74, and then travel in a downstream direction 63 through the premixer tubes 52 until exiting into the combustor 16. Again, the exclusion of perforations 58 in the non-perforated section 76 is configured to increase residence time of the air flows in the premixer tubes 52, as the non-perforated section 76 essentially blocks entry of the airflows into the premixer tubes 52 and guides the airflows to the perforations 58 in the upstream perforated section 74. Furthermore, the upstream positioning of the perforations 58 enhances fuel-air mixing further upstream 57, thereby providing greater time for the fuel and air to mix prior to injection into the combustor 16. Likewise, the upstream positioning of the perforations 58 substantially reduces pressure oscillations in the fluid flows (e.g., air flow, gas flow, and liquid fuel flow), as the perforations create crosswise flows to enhance mixing with greater residence time to even out the pressure.

The gas fuel flowing through the galleries 62 may also serve to insulate the liquid fuel cartridges 70 and ensure that liquid fuel temperature remains low enough to reduce the possibility of coking. Coking is a condition where fuel begins to crack, forming carbon particles. These particles may become attached to inside walls of the liquid fuel cartridges 70. Over time, the particles may detach from the walls and clog the tip of the liquid fuel cartridge 70. The temperature at which coking occurs varies depending on the fuel. However, for typical liquid fuels, coking may occur at temperatures of greater than approximately 200, 220, 240, 260, 280, or 300 degrees Fahrenheit. As can be seen in FIG. 7, the liquid fuel cartridges 70 are disposed within the galleries 62 and gas fuel injectors 61. Therefore, the liquid fuel cartridges 70 may be completely surrounded by flowing gas. Similarly, when the turbine system 10 is operating in liquid fuel mode, the turbine system 10 may supply cooling air from the heat exchanger 37 to the galleries 62, thereby surrounding the liquid fuel cartridges 70 with insulating air flow. The gas fuel and/or air may serve to keep the liquid fuel within the liquid fuel cartridges 70 cool, reducing the possibility of coking.

After the fuel and air have properly mixed in the premixer tubes 52, the mixture may be ignited, resulting in a flame 78 downstream from the downstream portion 55 of each premixer tube 52. As discussed above, the flame 78 heats the fuel-nozzle 12 due to the relatively close location to the downstream portion 55 of the mini-nozzle cap 50. Therefore, as previously discussed, air from the first windows 54 flows through the downstream portion 55 of the mini-nozzle cap 50 to substantially cool the cap 50 of the fuel nozzle 12.

The number of premixer tubes 52 in operation may vary based on desired turbine system output. For example, during normal operation, every premixer tube 52 within the mini-nozzle cap 50 may operate to provide adequate mixing of fuel and air for a particular turbine power level. However, when the turbine system 10 enters a turndown mode of operation, the number of functioning premixer tubes 52 may decrease. When a turbine engine enters turndown, or low power operation, fuel flow to the combustors 16 may decrease to the point where the flame 78 is extinguished. Similarly, under low load conditions, the temperature of the flame 78 may decrease, resulting in increased emissions of oxides of nitrogen (NOx) and carbon monoxide (CO). To maintain the flame 78 and ensure that the turbine system 10 operates within acceptable emissions limits, the number of premixer tubes 52 operating within a fuel nozzle 12 may decrease. For example, the outer ring of premixer tubes 52 may be deactivated by interrupting fuel flow to the outer liquid fuel cartridges 70. Similarly, the flow of gas fuel to the third gallery 68 may be interrupted. In this manner, the number of premixer tubes 52 in operation may be reduced. As a result, the flame 78 generated by the remaining premixer tubes 52 may be maintained at a sufficient temperature to ensure that it is not extinguished and emission levels are within acceptable parameters.

In addition, the number of premixer tubes 52 within each mini-nozzle cap 50 may vary based on turbine system 10 design considerations. For example, larger turbine systems 10 may employ a greater number of premixer tubes 52 within each fuel nozzle 12. While the number of premixer tubes 52 may vary, the size and shape of the mini-nozzle cap 50 may be the same for each application. In other words, turbine systems 10 that use higher fuel flow rates may employ mini-nozzle caps 50 with a higher density of premixer tubes 52. In this manner, turbine system 10 construction costs may be reduced because a common mini-nozzle cap 50 may be used for most turbine systems 10, while the number of premixer tubes 52 within each cap 50 may vary. This manufacturing method may be less expensive than designing unique fuel nozzles 12 for each application.

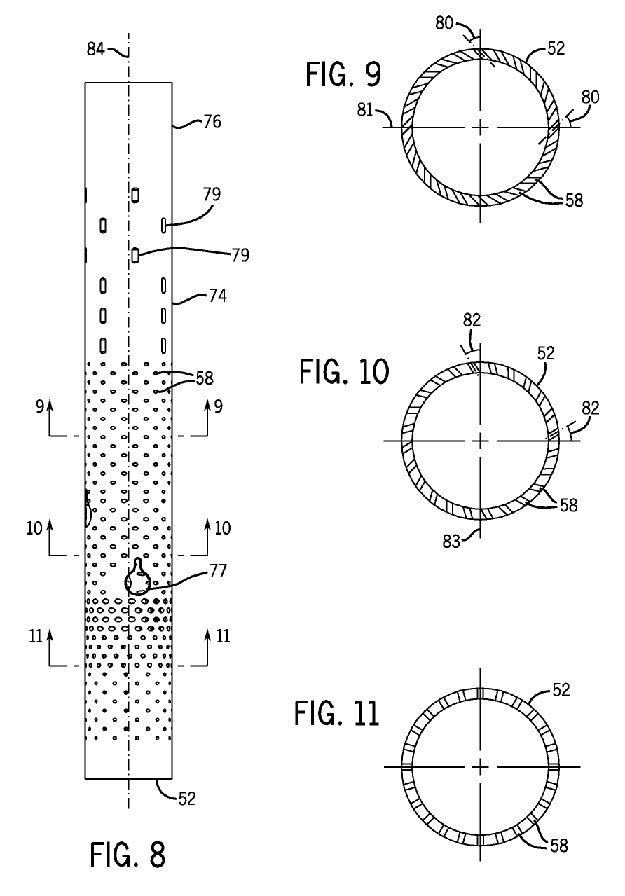

FIG. 8 is a side view of a premixer tube 52 that may be used in the fuel nozzle 12 of FIG. 4. As can be seen in FIG. 8, the premixer tube 52 is divided into the perforated section 74 and the non-perforated section 76. In the illustrated embodiment, the perforated section 74 is positioned upstream of the non-perforated section 76. In this configuration, air flowing into the perforations 58 may mix with fuel entering through the base of the premixer tube 52 via a fuel injector (not shown). The mixing fuel and air may then pass into the non-perforated portion 76, where additional mixing may occur.

Air and fuel pressures typically fluctuate within a gas turbine engine. These fluctuations may drive a combustor oscillation at a particular frequency. If this frequency corresponds to a natural frequency of a part or subsystem within the turbine engine, damage to that part or the entire engine may result. Increasing the residence time of air and fuel within the mixing portion of the combustor 16 may reduce combustor driven oscillations. For example, if air pressure fluctuates with time, longer fuel droplet residence time may allow air pressure fluctuations to average out. Specifically, if the droplet experiences at least one complete cycle of air pressure fluctuation before combustion, the mixture ratio of that droplet may be substantially similar to other droplets in the fuel stream. Maintaining a substantially constant mixture ratio may reduce combustor driven oscillations.

Residence time may be increased by increasing the length of the mixing portion of the combustor 16. In the present embodiment, the mixing portion of the combustor 16 corresponds to the premixer tubes 52. Therefore, the longer the premixer tubes 52, the greater residence time for both air and fuel. For example, the length to diameter ratio of each tube 52 may be approximately between 5 to 20, 10 to 15, or about 10.

The non-perforated section 76 may serve to increase premixer tube 52 length without allowing additional air to mix with the fuel. In this configuration, the air and fuel may continue to mix after the air has been injected through the perforations 58 and, thus, reduce combustor driven oscillations. In certain embodiments, the length of the perforated section 74 relative to the length of the non-perforated section 76 may be at least greater than approximately 2, 2.5, 3, 3.5, 4, 4.5, 5, 5.5, 6, 6.5, 7, 7.5, 8, 8.5, 9, 9.5, or 10. In one embodiment, the length of the perforated section 74 may be approximately 80% of the premixer tube 52 length (e.g., 8 inches), while the length of the non-perforated section 76 may be approximately 20% of the tube 52 length (e.g., 2 inches). However, the length ratios or percentages between these sections 74 and 76 may vary depending on flow rates and other design considerations, e.g., desired mixing and/or desire operability.

Residence time may also be increased by extending the effective path length of fluid flows (e.g., fuel droplets) through the premixer tubes 52. Specifically, air may be injected into the premixer tubes 52 in a swirling motion. This swirling motion may induce the droplets to travel through the premixer tubes 52 along a non-linear path (e.g., a random path or a helical path), thereby effectively increasing droplet path length. The amount of swirl may vary based on desired residence time.

Radial inflow swirling may also serve to keep liquid fuel droplets off the inner walls of the premixer tubes 52. If the liquid droplets become attached to the walls, they may remain in the tubes 52 for a longer period of time, delaying combustion. Therefore, ensuring that droplets properly exit the premixer tubes 52 may increase efficiency of the turbine system 10.

In addition, swirling air within the premixer tubes 52 may improve atomization of the liquid fuel droplets. The swirling air may enhance droplet formation and disperse droplets generally evenly throughout the premixer tube 52. As a result, efficiency of the turbine system 10 may be further improved.

As previously discussed, air may enter the premixer tubes 52 through perforations 58. These perforations 58 may be arranged in a series of concentric circles at different axial positions along the length of the premixer tubes 52. In certain embodiments, each concentric circle may have 24 perforations, where the diameter of each perforation is approximately 0.05 inches. The number and size of the perforations 58 may vary. For example, premixer tubes 52 may include large teardrop shaped perforations 77 configured to provide enhanced air penetration and mixing. In addition, intermediate sized slotted perforations 79 may be located toward the downstream end of premixer tubes 52 to generate a high degree of swirl. The perforations 58 may be angled along a plane perpendicular to the longitudinal axis of the premixer tube 52. The angled perforations 58 may induce swirl, the magnitude of which may be dependent on the angle of each perforation 58.

FIGS. 9, 10, and 11 are simplified cross-sectional views of the premixer tube 52 taken along lines 9-9, 10-10, and 11-11 of FIG. 8, further illustrating angled orientations of the perforations 58 at different axial positions along the length of the tube 52. For example, an angle 80 between perforations 58 and radial axis 81 is illustrated in FIG. 9. Similarly, an angle 82 between perforations 58 and radial axis 83 is illustrated in FIG. 10. Angles 80 and 82 may range between about 0 to 90 degrees, 0 to 60 degrees, 0 to 45 degrees, 0 to 30 degrees, or 0 to 15 degrees. By further example, the angles 80 and 82 may be about 5, 10, 15, 20, 25, 30, 35, 40, or 45 degrees, or any angle therebetween.

In certain embodiments, the angle of the perforations 58 may be the same at each axial location represented by lines 9-9, 10-10, and 11-11, as well as other axial positions along the length of the tube 52. However, in the illustrated embodiment, the angle of the perforations 58 may vary along the length of the tube 52. For example, the angle may gradually increase, decrease, alternate in direction, or a combination thereof. For example, the angle 80 of the perforations 58 shown in FIG. 9 is greater than the angle 82 of the perforations 58 shown in FIG. 10. Therefore, the degree of swirl induced by the perforations 58 in FIG. 9 may be greater than the degree of swirl induced by the perforations 58 in FIG. 10.

The degree of swirl may vary along the length of the perforated portion 74 of the premixer tube 52. The premixer tube 52 depicted in FIG. 8 has no swirl in the lower portion of the perforated section 74, a moderate amount of swirl in the middle portion, and a high degree of swirl in the upper portion. These degrees of swirl may be seen in FIGS. 11, 10 and 9, respectively. In this embodiment, the degree of swirl increases as fuel flows in the downstream direction through the premixer tube 52.

In other embodiments, the degree of swirl may decrease along the length of the premixer tube 52. In further embodiments, portions of the premixer tube 52 may swirl air in one direction, while other portions may swirl air in a substantially opposite direction. Similarly, the degree of swirl and the direction of swirl may both vary along the length of the premixer tube 52.

In yet another embodiment, air may be directed in both a radial and an axial direction. For example, the perforations 58 may form a compound angle within the premixer tube 52. In other words, perforations 58 may be angled in both a radial and axial direction. For example, the axial angle (i.e., angle between perforations 58 and longitudinal axis 84) may range between about 0 to 90 degrees, 0 to 60 degrees, 0 to 45 degrees, 0 to 30 degrees, or 0 to 15 degrees. By further example, the axial angle may be about 5, 10, 15, 20, 25, 30, 35, 40, or 45 degrees, or any angle therebetween. Compound-angled perforations 58 may induce air to both swirl in a plane perpendicular to the longitudinal axis of the premixer tube 52 and flow in an axial direction. Air may be directed either downstream or upstream of the fuel flow direction. A downstream flow may improve atomization, while an upstream flow may provide better mixing of the fuel and air. The magnitude and direction of the axial component of the airflow may vary based on axial position along the length of the premixer tube 52.

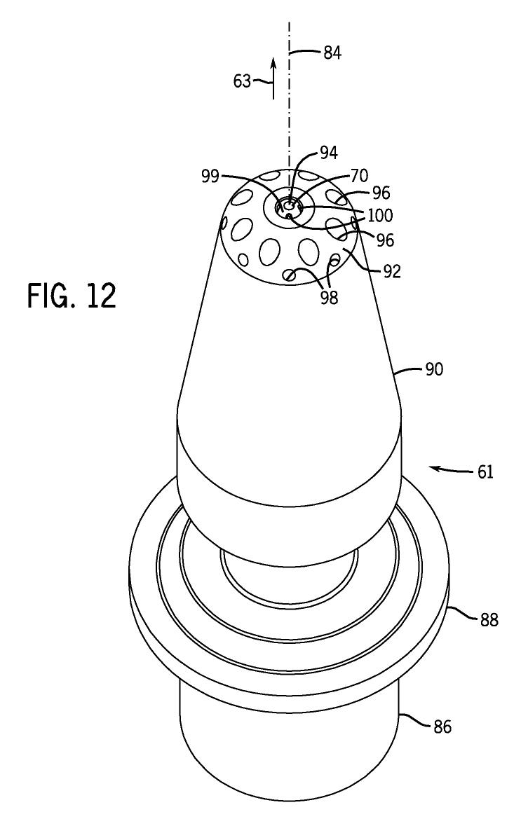

FIG. 12 is a perspective view of a liquid fuel cartridge 70 disposed within a gas fuel injector 61. As previously discussed, the liquid fuel cartridge 70/gas fuel injector 61 assembly is disposed within a respective premixer tube 52 and configured to provide liquid and/or gas fuel for combustion. The gas fuel injector 61 includes a base 86, a flange 88 and a conical shaped body 90. The base 86 is configured to receive liquid and/or gas fuel from fuel supplies 14 and/or 15, respectively. The flange 88 is configured to secure the gas fuel injector 61 to the end cover 38 and provide a seal between the gas fuel injector 61 and a respective gallery 62. The body 90 includes a tip portion 92 having various ports for air and fuel injection. For example, certain embodiments may include a first port for liquid fuel injection, a second port disposed about the first port and configured to inject gas fuel and/or air, and a third port radially offset from the first and second ports and configured to inject gas fuel and/or air. As illustrated, the tip 92 includes a second or central gas/air port 94, compressor air ports 96, and third or radial gas/air ports 98. The illustrated embodiment includes eight compressor air ports 96. Alternative embodiments may include more or fewer ports 96. For example, certain embodiments may include 12, 14, 16, 18, or more compressor air ports 96. As discussed in detail below, the body 90 include passages configured to receive air from the compressor 22 and direct the air to the ports 96. The air flowing through the ports 96 may combine with the air that passes through the perforations 58 in the premixer tubes 52, and mix with the injected gas and/or liquid fuel. Because the air from the compressor air ports 96 is injected substantially along the longitudinal axis 84, the air may establish a flow substantially in the downstream direction 63.

The ports 94 and 98 are configured to supply gas fuel and/or air into the premixer tubes 52. As discussed in detail below, selectable flow passages extend to the ports 94 and 98. The selectable flow passages are configured to convey gas fuel to the ports 94 and 98 when the turbine system 10 is operating in a gas fuel mode, air to the ports 94 and 98 when the turbine system 10 is operating in a liquid fuel mode, and a combination of air and gas fuel to the ports 94 and 98 when the turbine system 10 is operating in a transition mode. As previously discussed, the air may be supplied to the selectable flow passages via the compressor 35 and heat exchanger 37. The flow of gas fuel and/or air through the selectable flow passages may serve to thermally insulate the liquid fuel within the liquid fuel cartridge 70 from the hot combustion gases. In addition, the flow of air through the central port 94 during periods of liquid fuel operation may serve to enhance atomization of liquid fuel emanating from the liquid fuel cartridge 70. Specifically, interaction between the liquid fuel and the surrounding high pressure air may cause the liquid to break up into droplets. Furthermore, some of the energy from the air may be transferred to the liquid fuel, increasing liquid droplet velocity. Because droplet velocity is a function of air flow rate, this atomization configuration may enable the turbine system 10 to vary droplet velocity independently from a liquid fuel flow rate. Therefore, proper atomization may be achieved throughout a range of turbine operating conditions. In addition, a tip 99 of the liquid fuel cartridge may include circumferentially spaced longitudinal grooves 100 configured to direct the flow of air through the port 94, thereby enhancing liquid fuel droplet atomization.

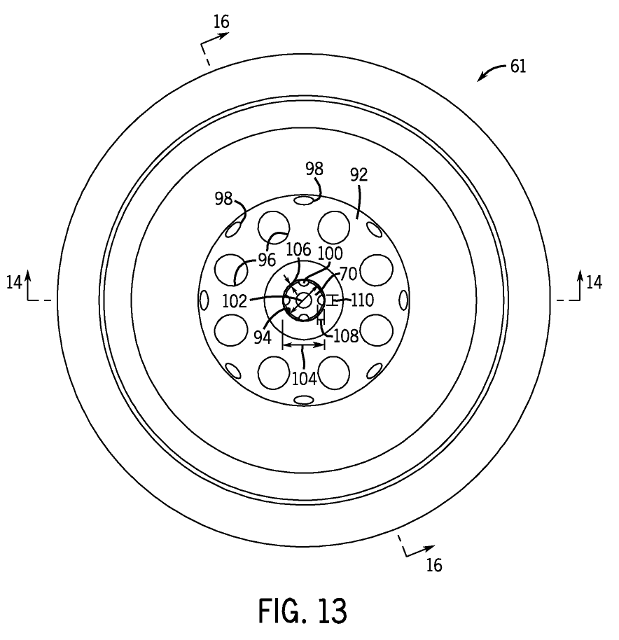

FIG. 13 is a top view of the liquid fuel cartridge 70 disposed within the gas fuel injector 61. As illustrated, the compressor air ports 96 are radially offset from the central gas/air port 94 and spaced about the tip 92 in a first circumferential arrangement. The radial gas/air ports 98 are also radially offset from the central gas/air port 94 and spaced about the tip 92 in a second circumferential arrangement. The present embodiment includes eight gas/air ports 98, each circumferentially positioned at the approximate midpoint between compressor air ports 96. Alternative embodiments may include more or fewer ports 98. For example, certain embodiments may include 12, 14, 16, 18, or more gas/air ports 98. In addition, the circumferential arrangement of compressor air ports 96 and/or radial gas/air ports 98 may vary in further embodiments. Furthermore, an outer diameter 102 of the liquid fuel cartridge 70 is less than an inner diameter 104 of the central gas/air port 94. Because the liquid fuel cartridge 70 is substantially centered within the port 94, a gap 106 (e.g., annular space) is established between the liquid fuel cartridge 70 and the port 94. Air from the heat exchanger 37 and/or gas fuel flowing to the port 94 may exit the gas fuel injector 61 through the gap 106. As appreciated, the width of this gap 106 may influence the flow rate and/or the velocity of air and/or gas fuel flowing through the central port 94. Therefore, flow properties of the gas fuel and/or air may be adjusted by varying the diameter 104 of the port 94 and/or the diameter 102 of the liquid fuel cartridge 70. For example, a liquid fuel cartridge 70 may be selected from a set of cartridges 70, each having a different diameter 102 to provide a proper air flow to achieve effective atomization for a particular liquid fuel (e.g., a liquid fuel having a particular viscosity).

Similarly, the number and/or configuration of the grooves 100 may be adjusted based on desired air and/or gas fuel flow properties. For example, the amount of air flowing through the central port 94 during periods of liquid fuel operation may be adjusted by varying the number of grooves 100. While four grooves 100 are included in the present embodiment, more or fewer grooves 100 may be employed in alternative embodiments. For example, certain embodiments may include 6, 8, 10, 12, or more grooves 100. In addition, a radial dimension 108 of the grooves 100 and/or a circumferential dimension 110 of the grooves 100 may be varied in alternative embodiments to establish a desired flow of gas fuel and/or air into the premixer tubes 52. In certain embodiments, a particular liquid fuel cartridge 70 may be selected from a set of liquid fuel cartridges, each having a different number and/or configuration of grooves 100.

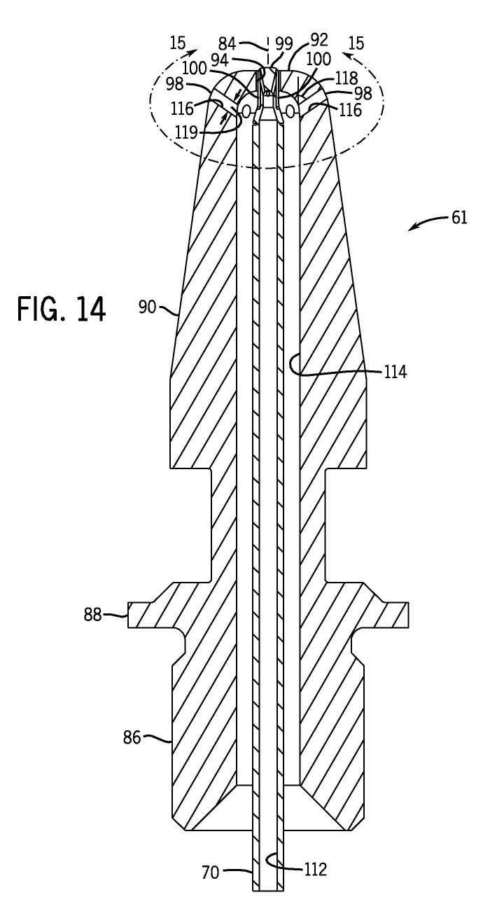

FIG. 14 is a cross-sectional side view of the liquid fuel cartridge 70 disposed within the gas fuel injector 61, taken along line 14-14 of FIG. 13. As illustrated, the liquid fuel cartridge 70 includes a liquid fuel passage 112 configured to flow liquid fuel to the tip 99. As discussed in detail below, the tip 99 includes liquid fuel ports configured to supply liquid fuel to the premixer tubes 52. The gas fuel injector 61 includes a selectable flow passage 114 configured to flow air and/or gas fuel to a series of intermediate flow passages 116. The intermediate flow passages 116 each extend to a respective port 98 configured to supply gas fuel and/or air to the premixer tube 52. In addition, the selectable flow passage 114 extends to the central port 94 (e.g., annular space or gap 106) to provide atomization air to the liquid fuel flow during periods of liquid fuel operation and gas fuel to the premixer tube 52 during periods of gas fuel operation. Thus, the flow of atomization air and/or gas fuel from the selectable flow passage 114 is split between the ports 98 and the central port 94 (e.g., gap 106). As illustrated, each intermediate flow passage 116 is oriented at an angle 118 with respect to the longitudinal axis 84. The angle 118 may be particularly configured to establish a flow pattern within the premixer tube 52 to facilitate proper mixing of fuel and air. For example, the angle 118 may be approximately between 0 to 90, 10 to 80, 20 to 70, 30 to 60, 40 to 50, or about 45 degrees. In further embodiments, the angle 118 may be greater than approximately 60 degrees. Furthermore, a diameter 119 of each intermediate flow passage 116 may be configured to establish a desired flow rate of gas fuel and/or air into the premixer tube 52. In addition, the diameter 119 of the intermediate flow passages 116 may be adjusted to vary gas fuel and/or air flow from the central port 94. For example, decreasing the diameter 119 may restrict flow through the radial ports 98 and increase flow through the central port 94. In the present embodiment, the diameter 119 is approximately 50% of the diameter 104 of the central gas/air port 94. In further embodiments, the diameter 119 may be greater than approximately 10%, 20%, 30%, 40%, 50%, 60%, 70%, 80%, 90%, 100%, or more of the diameter 104 of the central port 94.

As illustrated, the liquid fuel passage 112 is disposed within the selectable fuel passage 114. In addition, the tip 99 of the liquid fuel cartridge 70 is disposed within the central port 94 of the gas fuel injector 61. In this configuration, the liquid fuel within the cartridge 70 is surrounded by gas fuel and/or air to the tip 99 of the liquid fuel cartridge 70. This configuration may provide effective thermal insulation (i.e., thermal isolation or cooling) between the hot combustion gases and the liquid fuel, thereby substantially reducing or eliminating coking. For example, during periods of liquid fuel operation, cooled air from the heat exchanger 37 may flow through the selectable flow passage 114 and exit the central port 94 (e.g., annular space or gap 106), thereby surrounding the liquid fuel with thermally insulating air. Similarly, during transition periods, gas fuel and/or air may provide the thermal insulation. For example, if the turbine system 10 is operating in a liquid fuel mode and transition to a gas fuel mode is desired, air flow through the selectable flow passage 114 may be reduced, while a flow rate of gas fuel is gradually increased. During this period, the combination of gas fuel and air may provide sufficient thermal insulation to the liquid fuel to substantially reduce or eliminate coking. Once a desired gas fuel flow rate is achieved and the air flow through the selectable flow passage 114 has been terminated, the liquid flow rate may be gradually reduced until liquid flow is terminated. During the period of liquid fuel flow reduction, the gas fuel may provide effective thermal insulation to substantially reduce or eliminate coking of the liquid fuel. Conversely, if the turbine system 10 is operating in a gas fuel mode and transition to a liquid fuel mode is desired, a flow rate of liquid fuel through the liquid flow passage 112 may be gradually increased until the liquid fuel is flowing at a desired rate. During this period, the gas fuel may provide the insulation. Once a desired liquid flow rate is achieved, the gas fuel flow rate may be decreased, while air flow through the selectable flow passage 114 is increased until gas fuel flow is terminated. The flow of air may serve to substantially purge the gas fuel from the selectable flow passage 114 and the intermediate flow passages 116. During this transition period, the combination of gas fuel and air may serve to thermally insulate the liquid fuel from the hot combustion gases. Therefore, the selectable flow passage 114 may provide effective thermal insulation to the liquid fuel during each phase of turbine system operation, thereby substantially reducing or eliminating coking.

Furthermore, the cooling air flow from the heat exchanger 37 provided during periods of liquid fuel operation may serve to reduce emissions. In certain configurations, the cooling air flow may reduce emissions of exhaust gases to levels below regulatory limits without employing an expensive and complex water injection system. Certain turbine systems 10 may operate a water injection system during periods of liquid fuel operation to reduce emissions of oxides of sulfur (SOx), oxides of nitrogen (NOx) and/or carbon monoxide (CO), among other exhaust emissions. Water injection systems typically inject water into the combustor 16 through the fuel nozzle 12 to reduce combustion temperatures. The reduced temperatures may decrease emissions of regulated exhaust gases. However, water injection systems typically employ various pumps, valves, controllers and manifolds to deliver water to the turbine system 10. Such configurations are generally complex and expensive to produce and maintain. In addition, providing large quantities of water to the turbine system 10 may increase operational costs.

The present embodiments may reduce combustion temperatures by injecting cooling air flow from the heat exchanger 37. As previously discussed, the temperature of the air from the heat exchanger 37 may be lower than the coking temperature of the liquid fuel, e.g., about 280 degrees Fahrenheit. Injection of this cooling air may reduce the temperature of the combustion process such that exhaust emissions are reduced below regulatory limits without the use of a water injection system. Furthermore, the additional air may result in a lean fuel/air mixture. As appreciated, leaner mixtures may provide cooler combustion products compared to an ideal (i.e., stoichiometric) fuel/air ratio. The combination of the leaner mixture ratio and the injection of cooling air may decrease combustion temperatures and reduce emissions, thereby obviating the use of a water injection system.

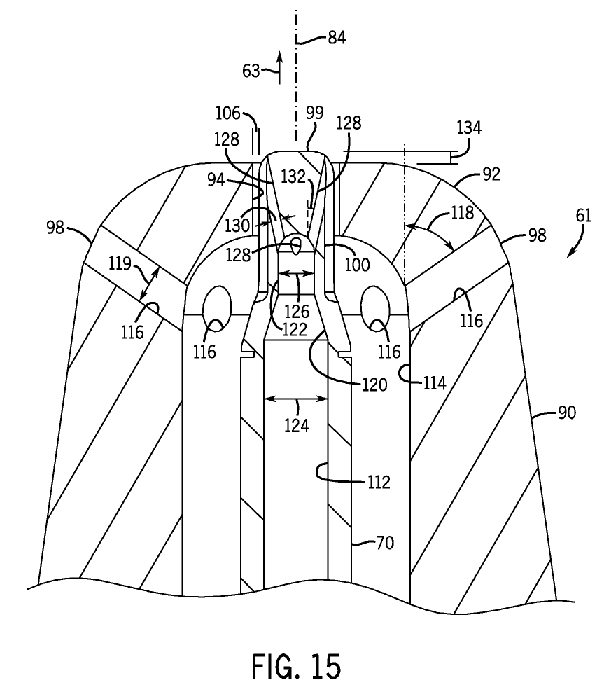

FIG. 15 is a detailed cross-sectional side view of the liquid fuel cartridge 70 disposed within the gas fuel injector 61 taken within line 15-15 of FIG. 14. As illustrated, the liquid fuel passage 112 includes a converging section 120 (i.e., converging with respect to the downstream direction 63) and a fuel distribution node 122. A diameter 124 of the liquid fuel passage 112 is larger than a diameter 126 of the fuel distribution node 122. Therefore, as appreciated, a velocity of the fuel flowing through the liquid fuel passage 112 may increase through the converging section 120, thereby providing the fuel distribution node 122 with higher velocity fuel for atomization. In the present embodiment, the diameter 124 of the liquid fuel passage 112 is approximately twice as large as the diameter 126 of the fuel distribution node 122. In alternative embodiments, the ratio of diameter 124 to diameter 126 may be greater than approximately 1, 1.2, 1.4, 1.6, 1.8, 2.2., 2.4, 2.6, 2.8, 3, or more. In certain embodiments, a liquid fuel cartridge 70 having a particular ratio of diameter 124 to diameter 126 may be selected from a set of cartridges 70 having varying ratios. In this manner, an appropriate liquid fuel cartridge 70 may be selected to achieve a desired liquid fuel velocity within the distribution node 122 based on the properties (e.g., viscosity) of a particular liquid fuel provided by the liquid fuel supply 15.

The fuel distribution node 122 flows the liquid fuel to first or liquid fuel ports 128 within the tip 99 of the liquid fuel cartridge 70. The present embodiment includes four liquid fuel ports 128 that diverge in the downstream direction 63. However, alternative embodiments may include more or fewer liquid fuel ports 128. For example, certain embodiments may include 6, 7, 8, 9, 10, or more liquid fuel ports 128. In certain embodiments, a liquid fuel cartridge 70 having a particular number of liquid fuel ports 128 may be selected from a set of cartridges 70 having varying numbers of liquid fuel ports 128, thereby establishing proper liquid fuel flow for a given fuel. In further embodiments, the liquid fuel ports 128 may form a helical pattern configured to impart swirl on the liquid fuel. As illustrated, an exit of each liquid fuel port 128 is disposed adjacent to a respective groove 100. In this configuration, when the turbine system 10 is operating in liquid fuel mode, airflow along the groove 100 may establish a low pressure region adjacent to the liquid fuel port 128, thereby increasing liquid fuel velocity and enhancing atomization of liquid fuel droplets. In alternative configurations, the liquid fuel ports 128 may be circumferentially offset from the grooves 100. In further configurations, the liquid fuel ports 128 may be substantially aligned with the longitudinal axis 84 and configured to emanate liquid fuel droplets from the tip 99 substantially in the downstream direction 63. Alternative embodiments may employ grooves 100 forming a helical pattern configured to impart swirl on the airflow along the grooves 100 and the liquid fuel.

Each liquid fuel port 128 may be configured for a particular application based on the fuel provided by the liquid fuel supply 15. Specifically, a diameter 130 of each liquid fuel port 128 may be particularly configured to establish a desired flow rate of liquid fuel into the premixer tubes 52. In the present embodiment, the diameter 130 of each liquid fuel port 128 is approximately 25% of the diameter 126 of the liquid fuel distribution node 122. The diameter 130 of the liquid fuel ports 128 may vary in alternative embodiments. For example, the diameter 130 may be greater than approximately 10%, 15%, 20%, 30%, 35%, 40%, 45%, 50%, or more of the diameter 126 of the liquid fuel distribution node 122. Furthermore, each liquid fuel port 128 may be oriented at an angle 132 with respect to the longitudinal axis 84. In the present embodiment, the angle 132 of the liquid fuel port 128 is approximately 12 degrees. Alternative embodiments may employ liquid fuel ports 128 oriented at larger or smaller angles 132. For example, certain embodiments may include angles 132 between approximately 0 to 90, 10 to 80, 20 to 70, 30 to 60, 40 to 50, or about 45 degrees. By further example, angle 132 may be approximately 0, 6, 12, 18, 24, or 30 degrees. The angle 132 may be particularly configured to achieve proper atomization of liquid fuel droplets within the premixer tube 52. In certain embodiments, a liquid fuel cartridge 70 may be selected from a set of cartridges 70, each employing liquid fuel ports 128 oriented at different angles 132. In this manner, an appropriate liquid fuel cartridge 70 may be selected to achieve a desired atomization pattern based on the properties of the liquid fuel being supplied by the liquid fuel supply 15.

In addition, the tip 99 of the liquid fuel cartridge 70 may extend a distance 134 axial beyond the downstream end of the tip 92 of the gas fuel injector 61. In the present embodiment, the distance 134 is approximately equal to the diameter 130 of the liquid fuel ports 128. In further embodiments, the distance 134 may be greater or less than the diameter 130. For example, the distance 134 may be greater than approximately 0.25, 0.5, 0.75, 1.25, 1.5, 1.75, 2, or more times the diameter 130 of the liquid fuel ports 128. In alternative embodiments, the tip 99 may be substantially flush with the tip 92. In further embodiments, the tip 99 may be recessed within the central port 94. The position of the tip 99 of the liquid fuel cartridge 70 relative to the tip 92 of the gas fuel injector 61 may affect the atomization of liquid fuel droplets within the premixer tube 52. Therefore, a length of the liquid fuel cartridge 70 may be selected to achieve a desired offset 134 between the tip 99 and the tip 92.

The liquid fuel cartridge 70 may be selected to achieved proper atomization for a particular fuel. Specifically, the liquid fuel cartridge 70 may be configured to produce liquid fuel droplets of a particular size. As appreciated, smaller liquid fuel droplets provide an increased surface area, resulting in a more complete combustion reaction. Therefore, the liquid fuel cartridge 70 may be configured to provide liquid fuel droplets having a diameter less than approximately 50 microns. For example, the liquid fuel cartridge 70 may produce droplets having a diameter of less than about 15, 20, 25, 30, 35, 40, 45, or 50 microns. Such a configuration may enhance the combustion process and result in increased efficiency and decreased emissions. Similarly, the spay pattern from the liquid fuel cartridge 70 may be limited to a substantially conical shape having a particular angle of divergence in the downstream direction 63. Specifically, the divergence angle may be configured to maintain the spray of liquid fuel droplets within the premixer tube 52. For example, the spray cone may be limited to an angle of approximately between 0° to 40°, 5° to 35°, 10° to 30°, 15° to 25°, or about 20°. In this manner, fuel droplets may remain in the premixer tube 52 such that proper mixing of fuel and air may be achieved. As previously discussed, the properties of the liquid fuel cartridge 70 and/or the gas fuel injector 61 that may affect atomization include the gap 106 between the liquid fuel cartridge 70 and the central port 94, the number of grooves 100, the radial dimension 108 of the grooves 100, the circumferential dimension 110 of the grooves 100, the diameter 126 of the distribution node 122 with respect to the diameter 124 of the liquid fuel passage 112, the number of liquid fuel ports 128, the diameter 130 of each liquid fuel port 128, the angle 132 of each liquid fuel port 128, and the downstream distance 134 of the tip 99 beyond the tip 92. These properties may be particularly selected to achieve proper atomization. In addition, a liquid fuel cartridge 70 may be selected from a set of cartridges 70, each having one or more different properties. In this manner, the turbine system 10 may be easily configured or reconfigured for a particular fuel.

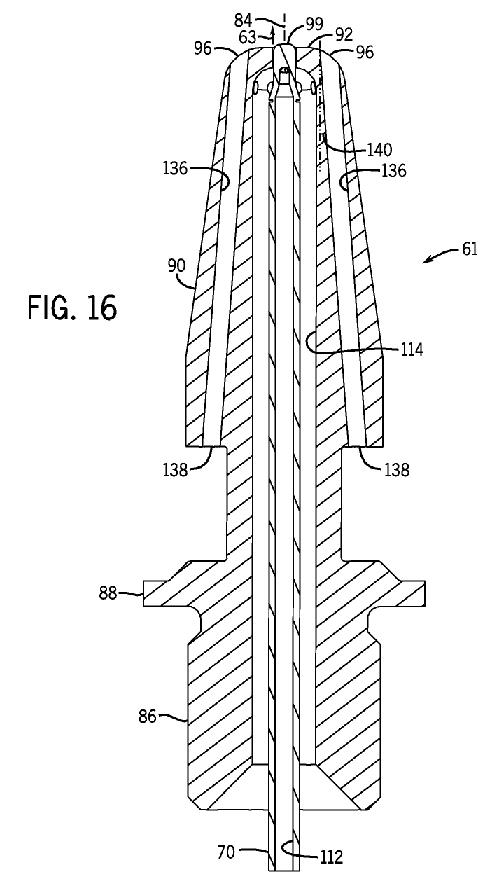

FIG. 16 is a cross-sectional side view of the liquid fuel cartridge 70 disposed within the gas fuel injector 61, taken along line 16-16 of FIG. 13. This cross-section illustrates compressor air passages 136 that convey air in a substantially downstream direction 63 from inlets 138 at an upstream portion of the body 90 to the compressor air ports 96. Specifically, as best shown in FIG. 5, air from the compressor 22 is directed through the second windows 56 to the inlets 138. As appreciated, the number of inlets 138 may correspond to the number of compressor air ports 96 within the body 90 of the gas fuel injector 61. The compressor air passages 136 may be oriented at an angle 140 relative to the longitudinal axis 84. In the present embodiment, angle 140 may be approximately 5°. Alternative embodiments may include larger or smaller angles 140. For example, certain embodiments may include angles 140 approximately between 0° to 20°, 2° to 18°, 4° to 16°, 6° to 14°, 8° to 12°, or about 10°. The angle 140 of the compressor air passages 136 relative to the longitudinal axis 84 may affect atomization of the liquid fuel droplets when the turbine system 10 is operating in the liquid fuel mode. Similarly, the angle 140 may affect the flow of gas fuel through the premixer tube 52 during periods of gas fuel operation. As previously discussed, the number of ports 96 may be configured for a particular turbine system application.

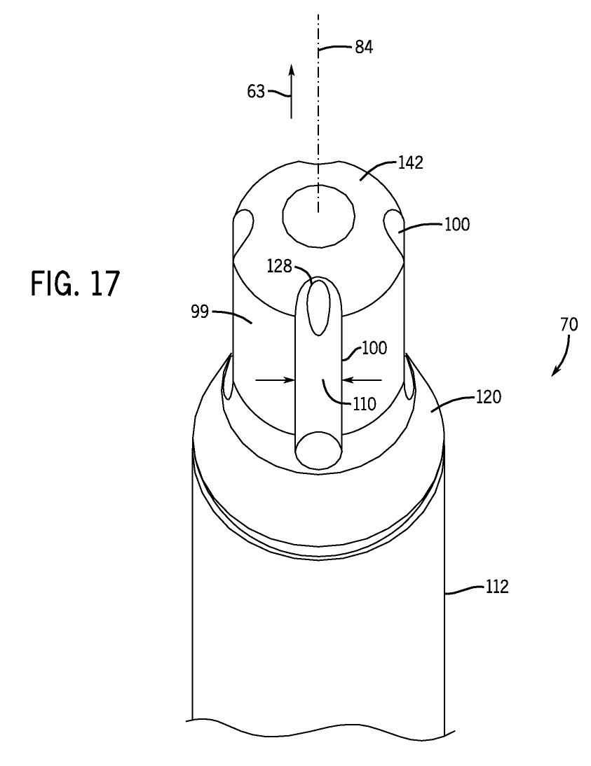

FIG. 17 is a perspective view of the tip 99 of the liquid fuel cartridge 70. As previously discussed, the tip 99 includes longitudinal grooves 100 having a circumferential dimension 110. As best shown in this figure, the liquid fuel ports 128 terminate adjacent to the grooves 100. This configuration may provide enhanced atomization by establishing a low pressure region adjacent to the ports 128 due to the flow of air along the grooves 100. The lower pressure region may serve to increase the exit velocity of the liquid fuel from the ports 128, thereby establishing reduced droplet size and increased droplet velocity. In alternative configurations, the liquid fuel ports 128 may terminate at an end cap 142 of the tip 99. This configuration may emit liquid droplets substantially in the downstream direction 63.

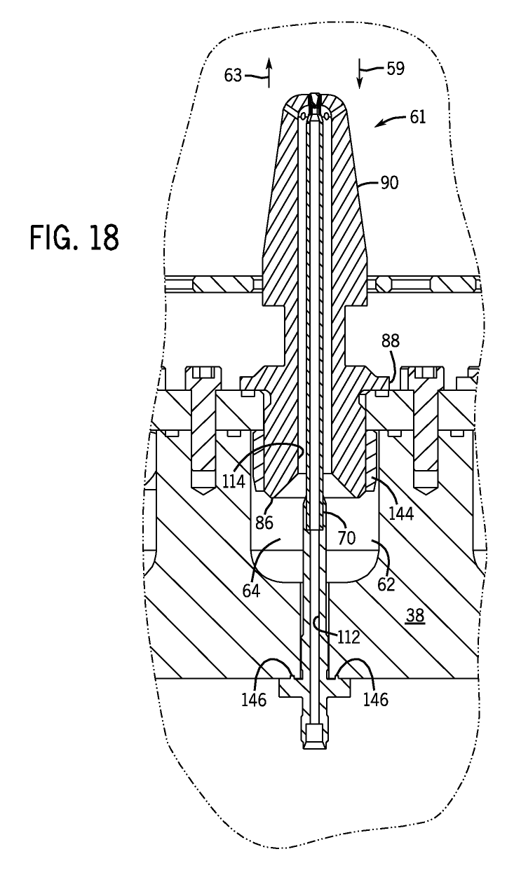

FIG. 18 is a cross-sectional side view of the gas fuel injector 61 disposed within the end cover 38 (see FIGS. 3 through 7). As illustrated, the gas injector 61 is coupled to the end cover 38 by a fastener 144 secured to the base portion 86 of the gas injector 61. The fastener 144 blocks movement of the gas fuel injector 61 in the downstream direction 63, while the flange 88 blocks movement of the injector 61 in the upstream direction 59. In certain embodiments, the fastener 144 and the base portion 86 may include mating threads. The liquid fuel cartridge 70 is secured to the end cover 38 by bolts 146. In certain embodiments, 1, 2, 3, 4, 5, 6, 7, 8, or more bolts 146 may secure the liquid fuel cartridge 70 to the end cover 38. However, the liquid fuel cartridge 70 is not directly coupled to the gas fuel injector 61. In this configuration, the liquid fuel cartridge 70 may be removed from the end cover 38 by disengaging the bolts 146. Therefore, liquid fuel cartridges 70 may be easily replaced to facilitate fuel nozzle maintenance and provide the turbine system 10 with a liquid fuel cartridge 70 particularly configured for a given application. For example, properties of the liquid fuel cartridges 70 described above may be selected based on the type of liquid fuel supplied by the liquid fuel supply 15. Therefore, operation of the turbine system 10 may be tailored to a particular fuel without extensive reconfiguration of the fuel nozzle 12.

In addition, each gallery 62 may be configured to provide gas fuel to the selectable flow passage 114 during periods of gas fuel operation, cooling air during periods of liquid fuel operation, or a combination of gas and air during transition periods. For example, both gas fuel from the gas fuel supply 14 and air from the heat exchanger 37 may be routed to the galleries 62 through one or more valves. These valves may be adjusted to provide proper flow of air and/or gas fuel to the galleries 62 based on the particular operating mode of the turbine system 10. The gas fuel and/or cooling air may flow through each gallery 62 to a respective selectable flow passage 114. In this manner, liquid fuel flowing through the liquid fuel passages 112 may be insulated from hot combustion gases by the surrounding gas fuel and/or cooling air, thereby substantially reducing or eliminating coking within the liquid fuel passage 112.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a fuel injector, comprising:
a liquid fuel passage leading to a liquid fuel port; and
a gas fuel passage leading to a gas fuel port;
an air compressor configured to supply an air flow to the gas fuel passage while a liquid fuel flows through the liquid fuel passage; and
a heat exchanger configured to cool the air flow.

2. The system of claim 1, wherein the air flow is cooled to a temperature configured to thermally insulate the liquid fuel flowing through the liquid fuel passage to reduce coking.

3. The system of claim 2, wherein the temperature is at least less than 280 degrees Fahrenheit.

4. The system of claim 1, wherein the fuel injector comprises a gas fuel mode, a liquid fuel mode, and a transition mode switching between the gas fuel mode and the liquid fuel mode, wherein the gas fuel mode provides for a gas fuel flow through the gas fuel passage and the air flow through the liquid fuel passage, and the liquid fuel mode provides for a liquid fuel flow through the liquid fuel passage and the air flow through the gas fuel passage.

5. The system of claim 4, wherein the transition mode switches between the gas fuel flow and the air flow through the gas fuel passage, and both the gas fuel flow and the air flow are at temperatures configured to thermally insulate the liquid fuel flow through the liquid fuel passage to reduce coking.

6. The system of claim 1, wherein the liquid fuel passage and the gas fuel passage are concentric with one another, and the liquid fuel port and the gas fuel port are both disposed at a tip portion of the fuel injector.

7. The system of claim 1, comprising a premixer tube disposed about the fuel injector, wherein the premixer tube comprises a perforated annular wall configured to receive another air flow.

8. The system of claim 1, wherein the gas fuel port is configured to direct the air flow to atomize the liquid fuel output from the liquid fuel passage.

9. The system of claim 1, wherein the air flow is cooled to a temperature configured to reduce emissions of regulated exhaust products.

10. The system of claim 1, comprising a turbine engine having the fuel injector.

11. A system, comprising:
a fuel injector, comprising:
a liquid fuel passage extending to a first port in a tip portion;
a selectable flow passage extending to a second port in the tip portion, wherein the selectable flow passage surrounds the liquid fuel passage to the tip portion, the selectable flow passage is configured to selectively receive a gas fuel flow and an air flow, and the selectable flow passage has a flow temperature configured to cool a liquid fuel flowing through the liquid fuel passage to reduce coking.

12. The system of claim 11, wherein the fuel injector comprises an air flow passage adjacent to the selectable flow passage configured to direct air from a compressor in a direction substantially parallel to the liquid fuel passage.

13. The system of claim 11, wherein the selectable flow passage is configured to direct the air flow to atomize the liquid fuel flow from the liquid fuel passage when the selectable flow passage is configured to receive the air flow.

14. The system of claim 11, wherein an angle of the first port relative to the second port is selectable to accommodate different liquid fuels.

15. The system of claim 11, wherein the fuel injector comprises a plurality of first ports extending from the liquid fuel passage, and wherein a number of first ports is selectable to accommodate different liquid fuels.

16. A system, comprising:
a fuel injector, comprising:
a liquid fuel passage extending to a first port; and
a selectable flow passage extending to a second port, wherein the selectable flow passage is configured to selectively receive a gas fuel flow during a gas fuel mode and an air flow during a liquid fuel mode, and the second port is configured to direct the air flow to atomize a liquid fuel flow from the first port during the liquid fuel mode.

17. The system of claim 16, wherein the air flow from the second port is adjustable to vary liquid droplet size, liquid droplet velocity, or a combination thereof, during the liquid fuel mode.

18. The system of claim 16, wherein the fuel injector comprises a third port extending from the selectable flow passage.

19. The system of claim 18, wherein an angle of the third port relative to the first port is selectable to accommodate different gas fuels.

20. The system of claim 16, wherein the selectable flow passage has a flow temperature configured to thermally insulate the liquid fuel flowing through the liquid fuel passage to reduce coking.
